(19) United States
(12) Patent Application Publication
(10) Pub. No.: US 2020/0016833 A1
(43) Pub. Date: Jan. 16, 2020

(54) THREE-DIMENSIONAL FORMING APPARATUS AND METHOD OF FORMING THREE-DIMENSIONAL OBJECT

(71) Applicant: Seiko Epson Corporation, Tokyo (JP)

(72) Inventors: Kohei YUWAKI, Shiojiri (JP); Koichi SAITO, Matsumoto (JP); Kazuhide NAKAMURA, Asahi (JP)

(21) Appl. No.: 16/508,475

(22) Filed: Jul. 11, 2019

(30) Foreign Application Priority Data
Jul. 12, 2018 (JP) 2018-131947

(51) Int. Cl. B29C 64/209; B29C 64/118; B33Y 10/00; B33Y 30/00; B22D 23/00

(52) U.S. Cl. CPC B29C 64/209; B29C 64/118; B22D 23/003; B33Y 30/00; B33Y 10/00

(57) ABSTRACT

A three-dimensional forming apparatus includes: a material melting portion that melts a material and obtains a forming material; a supply flow path through which the forming material supplied from the material melting portion is distributed; a first branched flow path and a second branched flow path to which the forming material is supplied from the supply flow path; a coupling portion that couples the supply flow path to a first branched flow path and a second branched flow path; a first nozzle that communicates with the first branched flow path; a second nozzle that communicates with the second branched flow path and that has a larger nozzle diameter than a nozzle diameter of the first nozzle; and a valve mechanism that is provided at the coupling portion.

The present application is based on, and claims priority from, JP Application Serial Number 2018-131947, filed Jul. 12, 2018, the disclosure of which is hereby incorporated by reference herein in its entirety.

### BACKGROUND

### 1. Technical Field

The present disclosure relates to a three-dimensional forming apparatus and a method of forming a three-dimensional object.

### 2. Related Art

For example, JP-A-2006-192710 discloses a three-dimensional forming apparatus, by which a melted thermoplastic material is extruded from an extruding nozzle that scans the material in accordance with present shape data to a base and a further melted material is laminated on the material cured on the base, thereby forming a three-dimensional object.

According to the aforementioned three-dimensional forming apparatus, it is possible to create a three-dimensional object with higher dimensional accuracy in a case in which a nozzle with a small diameter is used than in a case in which a nozzle with a large diameter is used since the melted material is extruded from one nozzle while producibility of the three-dimensional object is low since the flow rate of the melted material extruded from the nozzle is small. It is possible to further improve the producibility in the case in which the nozzle with the large diameter is used than in the case in which the nozzle with the small diameter is used since the flow rate of the melted material extruded from the nozzle is large while there is a probability that necessary dimensional accuracy cannot be secured.

### SUMMARY

Thus, it is desirable to provide a three-dimensional forming apparatus capable of improving the three-dimensional accuracy and the producibility of the three-dimensional object.

According to an aspect of the present disclosure, a three-dimensional forming apparatus is provided. The three-dimensional forming apparatus includes: a material melting portion that melts a material and obtains a forming material; a supply flow path through which the forming material supplied from the material melting portion is distributed; a first branched flow path and a second branched flow path to which the forming material is supplied from the supply flow path; a coupling portion that couples the supply flow path to the first branched flow path and the second branched flow path; a first nozzle that communicates with the first branched flow path; a second nozzle that communicates with the second branched flow path and that has a larger nozzle diameter than a nozzle diameter of the first nozzle; and a valve mechanism that is provided at the coupling portion. Switching between a first state in which communication between the supply flow path and the first branched flow path is established and coupling between the supply flow path and the second branched flow path is disconnected and a second state in which the communication between the supply flow path and the second branched flow path is established and the communication between the supply flow path and the first branched flow path is disconnected is performed using the valve mechanism.

### BRIEF DESCRIPTION OF THE DRAWINGS

FIG. 1 is an explanatory diagram illustrating a configuration outline of a three-dimensional forming apparatus according to a first embodiment.

FIG. 2 is an explanatory diagram illustrating a configuration outline of a first suctioning portion.

FIG. 3 is a schematic perspective view illustrating a configuration of a lower surface side of a flat screw.

FIG. 4 is a schematic plan view illustrating an upper surface side of a screw-facing portion.

FIG. 5 is a sectional schematic view illustrating an outline configuration of a valve mechanism in a first state.

FIG. 6 is a sectional schematic view illustrating an outline configuration of the valve mechanism in a second state.

FIG. 7 is a perspective view illustrating an outline configuration of a valve portion according to a first embodiment.

FIG. 8 is a flow chart illustrating details of three-dimensional forming processing according to the first embodiment.

FIG. 9 is an explanatory diagram illustrating a configuration outline of a three-dimensional forming apparatus according to a second embodiment.

FIG. 10 is a flow chart illustrating details of three-dimensional forming processing according to the second embodiment.

FIG. 11 is an explanatory diagram illustrating a configuration outline of a three-dimensional forming apparatus according to a third embodiment.

FIG. 12 is a perspective view illustrating an outline configuration of a valve portion according to the third embodiment.

### DESCRIPTION OF EXEMPLARY EMBODIMENTS

### A. First Embodiment

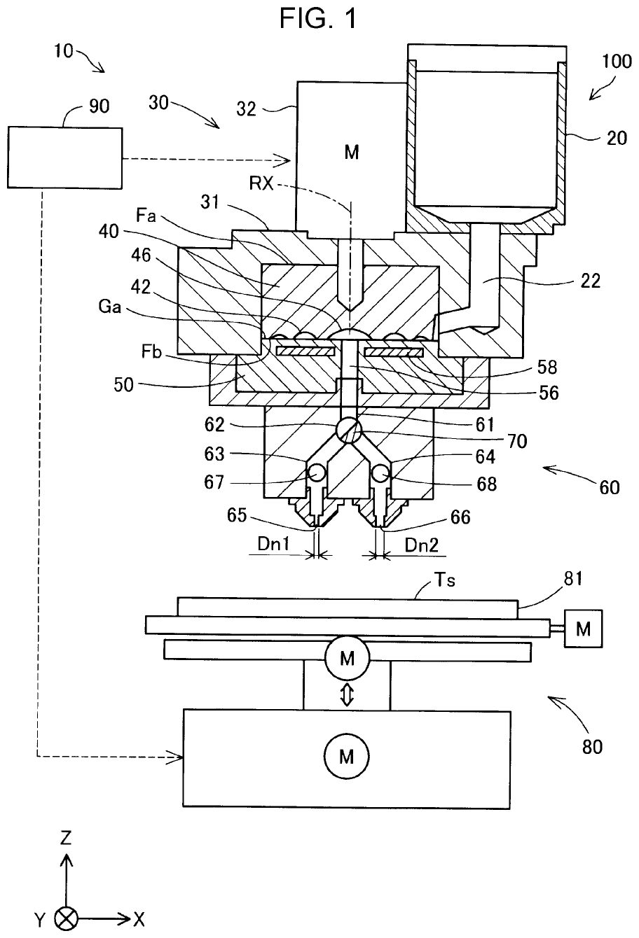

FIG. 1 is a diagram illustrating a schematic configuration of a three-dimensional forming apparatus 10 according to a first embodiment. In FIG. 1, arrows representing X, Y, and Z directions that perpendicularly intersect one another are illustrated. The X direction and the Y direction are directions in parallel to a horizontal plane, and the Z direction is a direction that is opposite to a vertical direction. The arrows representing the X, Y, and Z directions are appropriately illustrated such that the directions in the drawing correspond to those in FIG. 1 in other diagrams.

The three-dimensional forming apparatus 10 according to the embodiment includes a controller 90, a forming unit 100, a forming table 81, and a moving mechanism 80. The three-dimensional forming apparatus 10 forms a three-dimensional object by the forming unit 100 stacking a forming material, which will be described later, on the forming table 81 that is moved by the moving mechanism 80.

The controller 90 is a control device that controls operations of the forming unit 100 and the moving mechanism 80 and executes forming processing of forming a three-dimensional object. The operations include movement of a relative three-dimensional position of the forming unit 100 relative to the forming table 81. In the embodiment, the controller 90 is configured by a computer that includes one or more processors, a main storage device, and an input and output interface that inputs and outputs signals to and from the outside. The controller 90 exhibits various functions by the processor executing programs or commands read in the main storage device. Note that the controller 90 may be realized by a configuration a combination of a plurality of circuits for realizing at least a part of the respective functions instead of being configured by such a computer.

The forming unit 100 arranges a forming material in a paste form, which has been obtained by melting at least a part of a material in a solid form, on the forming table 81. The forming unit 100 includes a material supply portion 20 and a forming material producing portion 30 in addition to an ejecting portion 60. The forming material producing portion 30 may also be referred to as a “material melting portion”.

The material supply portion 20 supplies a material to the forming material producing portion 30. The material supply portion 20 is configured by, for example, a hopper that accommodates a material. The material supply portion 20 includes a discharge port on a lower side. This discharge port is coupled to the forming material producing portion 30 through a communication path 22. The material is poured into the material supply portion 20 in the form of a pellet, powder, or the like. In the embodiment, an ABS resin material in the form of a pellet is used.

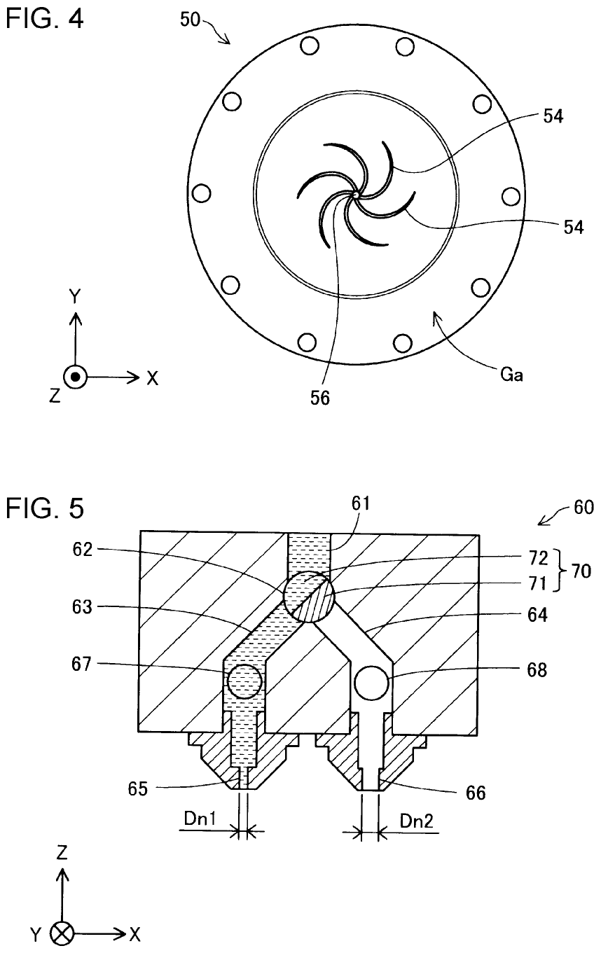

The forming material producing portion 30 melts at least a part of the material supplied from the material supply portion 20 to produce a paste-form forming material having fluidity and introduces the forming material into the ejecting portion 60. The forming material producing portion 30 includes a screw case 31, a driving motor 32, a flat screw 40, and a screw-facing portion 50. Specific configurations of the flat screw 40 and the screw-facing portion 50 are illustrated in FIGS. 3 and 4 described below, respectively.

The flat screw 40 has a substantially columnar shape with the height along a central axis thereof that is smaller than the diameter. The flat screw 40 is arranged such that the central axis thereof is parallel to the Z direction and rotates about the central axis. The central axis of the flat screw 40 conforms to a rotation axis RX thereof. In FIG. 1, the rotation axis RX of the flat screw 40 is illustrated by a one-dotted chain line.

The flat screw 40 is accommodated in the screw case 31. An upper surface Fa side of the flat screw 40 is coupled to the driving motor 32, and the flat screw 40 rotates in the screw case 31 due to a rotation driving force generated by the driving motor 32. The driving motor 32 is driven under the control of the controller 90.

A groove portion 42 is formed on a lower surface Fb of the flat screw 40 that is a surface intersecting the rotation axis RX. The lower surface Fb of the flat screw 40 faces an upper surface Ga of a screw-facing portion 50, and a material is supplied from the material supply portion 20 into the groove portion 42 provided in the lower surface Fb of the flat screw 40. Specific configurations of the flat screw 40 and the groove portion 42 will be described later with reference to FIG. 3.

In the screw-facing portion 50, a heater 58 for heating the material is embedded. The material supplied into the groove portion 42 of the rotating flat screw 40 flows along the groove portion 42 while at least a part thereof is being melted due to the rotation of the flat screw 40, and is introduced in to a center portion 46 of the flat screw 40. The paste-form material flowing into the center portion 46 is supplied to the ejecting portion 60 as the forming material through a communication hole 56 provided at the center of the screw-facing portion 50.

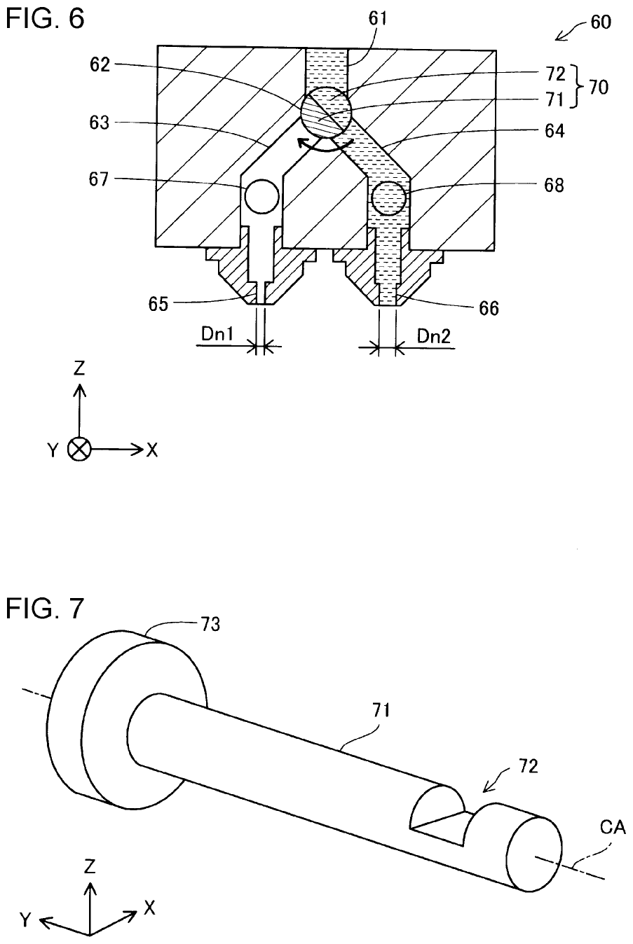

The ejecting portion 60 includes a supply flow path 61, which communicates with the communication hole 56 of the screw-facing portion 50, through which the forming material supplied from the forming material producing portion 30 is distributed, a first branched flow path 63 and a second branched flow path 64 to which the forming material is supplied from the supply flow path 61, a coupling portion 62 that couples the supply flow path 61, the first branched flow path 63, and the second branched flow path 64, a first nozzle 65 that communicates with the first branched flow path 63, a second nozzle 66 that communicates with the second branched flow path 64, and a valve mechanism 70 that is provided at the coupling portion 62. The forming material supplied to the ejecting portion 60 is ejected from any one of the first nozzle 65 and the second nozzle 66 toward the forming table 81. In the embodiment, a diameter Dn2 of the second nozzle 66 is larger than a diameter Dn1 of the first nozzle 65. The valve mechanism 70 performs switching between ejection of the forming material from the first nozzle 65 and the ejection thereof from the second nozzle 66. Details of the valve mechanism 70 will be described later with reference to FIGS. 5 and 6.

The ejecting portion 60 according to the embodiment includes a first suctioning portion 67 that is coupled to the first branched flow path 63 and a second suctioning portion 68 that is coupled to the second branched flow path 64. The first suctioning portion 67 is configured such that the first suctioning portion 67 can suction the forming material in the first branched flow path 63. The second suctioning portion 68 is configured such that the second suctioning portion 68 can suction the forming material in the second branched flow path 64.

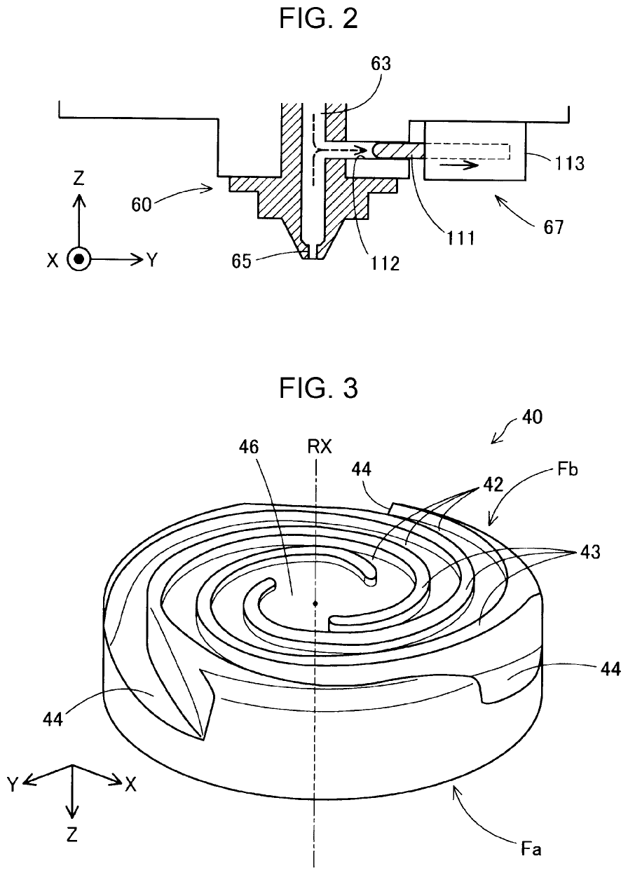

FIG. 2 is an explanatory diagram illustrating an outline configuration of the first suctioning portion 67. The first suctioning portion 67 according to the embodiment includes a cylinder 112 that is coupled to the first branched flow path 63, a plunger 111 that is accommodated in the cylinder 112, and a plunger drive portion 113 that drives the plunger 111. The plunger drive portion 113 is configured by an actuator such as a solenoid mechanism, a piezoelectric element, or a motor, for example. The plunger drive portion 113 causes drive force for instantaneously reciprocating the plunger 111 in the cylinder 112 under control of the controller 90. As represented by the arrow in FIG. 2, the negative pressure is caused in the cylinder 112, and the forming material in the first branched flow path 63 is suctioned into the cylinder 112 by the plunger 111 moving in a direction away from the first branched flow path 63. Note that since a configuration and operations of the second suctioning portion 68 are similar to those of the first suctioning portion 67, description thereof will be omitted.

Returning to FIG. 1, the moving mechanism 80 causes relative positions of the forming table 81, the first nozzle 65, and the second nozzle 66 to change. In the embodiment, the moving mechanism 80 causes the forming table 81 to move relative to the first nozzle 65 and the second nozzle 66. The moving mechanism 80 is configured by three-axis positioner that causes the forming table 81 to move in directions of three axes, namely an X direction, a Y direction, and a Z direction using drive force of three motors M. The moving mechanism 80 changes a relative positional relationship of the first nozzle 65, the second nozzle 66, and the forming table 81 under control of the controller 90.

Note that a configuration in which the moving mechanism 80 causes the forming unit 100 to move relative to the forming table 81 in a state in which the position of the forming table 81 is fixed may be employed, or a configuration in which each of the forming unit 100 and the forming table 81 is moved may be employed, instead of the configuration in which the forming table 81 is moved by the moving mechanism 80, in the three-dimensional forming apparatus 10. It is possible to change the positional relationship of the first nozzle 65, the second nozzle 66, and the forming table 81 even with such a configuration.

FIG. 3 is a schematic perspective view illustrating a configuration of the lower surface Fb side of the flat screw 40. For easy understanding of the technique, FIG. 3 illustrates the flat screw 40 in a state where a positional relationship between the upper surface Fa and the lower surface Fb illustrated in FIG. 1 is inverted in the vertical direction. In FIG. 3, the position of the rotation axis RX of the flat screw 40 during the rotation in the forming material producing portion 30 is indicated by a chain line. As described above with reference to FIG. 1, the groove portion 42 is provided on the lower surface Fb of the flat screw 40 facing the screw-facing portion 50. Hereinafter, the lower surface Fb will also be referred to as “groove-formed surface Fb”.

The center portion 46 of the groove-formed surface Fb of the flat screw 40 is configured as a concavity to which one end of the groove portion 42 is coupled. The center portion 46 faces the communication hole 56 of the screw-facing portion 50 illustrated in FIG. 1. In the embodiment, the center portion 46 intersects with the rotation axis RX.

The groove portion 42 of the flat screw 40 configures a so-called screw groove. The groove portion 42 extends in a spiral shape from the center portion 46 to an outer circumference of the flat screw 40 to form an arc. The groove portion 42 may be configured to extend in an involute curve shape or a helical shape. On the groove-formed surface Fb, a mountain-like portion 43 that configures a side wall portion of the groove portion 42 and extends along each groove portion 42 is provided.

The groove portion 42 continuously extends up to a material inlet port 44 that is formed on the side surface of the flat screw 40. The material inlet port 44 is a portion that receives the material supplied through the communication path 22 of the material supply portion 20.

When the flat screw 40 rotates, at least a part of the material supplied from the material inlet port 44 is heated and melted by the heater 58 described below in the groove portion 42 such that the fluidity of the material increases. The material flows to the center portion 46 through the groove portion 42, accumulates in the center portion 46, and is pressed out to the communication hole 56 of the screw-facing portion 50 due to an internal pressure generated in the center portion.

As illustrated in FIG. 3, the flat screw 40 includes three groove portions 42, three mountain-like portions 43, and three material inlet ports 44. The numbers of the groove portions 42, the mountain-like portions 43, and the material inlet ports 44 provided in the flat screw 40 are not limited to three. In the flat screw 40, only one groove portion 42 may be provided, and two or more groove portions 42 may be provided. In addition, the mountain-like portions 43 and the material inlet ports 44 corresponding to the number of the groove portions 42 may be provided.

FIG. 4 is a schematic plan view illustrating the upper surface Ga side of the screw-facing portion 50. As described above, the upper surface Ga of the screw-facing portion 50 faces the groove-formed surface Fb of the flat screw 40. Hereinafter, the upper surface Ga will also be referred to as “screw-facing surface Ga”.

On the screw-facing surface Ga, plural guide grooves 54 are formed. The guide groove 54 is coupled to the communication hole 56 formed at the center of the screw-facing surface Ga and extends in a spiral shape from the communication hole 56 to an outer circumference thereof. The guide grooves 54 function to guide the forming material to the communication hole 56. As described above with reference to FIG. 1, in the screw-facing portion 50, the heater 58 for heating the material is embedded. The melting of the material in the forming material producing portion 30 is realized by the heating by the heater 58 and the rotation of the flat screw 40. The molten material is pressed out to the supply flow path 61 of the ejecting portion 60 through the communication hole 56 of the screw-facing portion 50 and then is guided to the first branched flow path 63 or the second branched flow path 64. The material guided to the first branched flow path 63 or the second branched flow path 64 is finally ejected from the first nozzle 65 that communicates with the first branched flow path 63 or the second nozzle 66 that communicates with the second branched flow path 64.

A range that a path for melting at least a part of the material and guiding the material to the first nozzle 65 or the second nozzle 66 occupies in the Z direction is small since the flat screw 40 with a small size in the Z direction is used, as illustrated in FIG. 3, in the forming unit 100. In this manner, the size of the forming material generation mechanism is reduced since the flat screw 40 is used in the forming unit 100. Also, accuracy of ejection control of the forming material from the first nozzle 65 and the second nozzle 66 is enhanced, and it is possible to simply and efficiently form a three-dimensional object through the ejection process by using the flat screw 40.

A configuration in which the forming material in a state with fluidity is fed to the first nozzle 65 or the second nozzle 66 in a compressed manner is simply realized by the flat screw 40 being used in the forming unit 100.

With such a configuration, it is possible to control the amount of ejection of the forming material from the first nozzle 65 or the second nozzle 66 by controlling a rotation frequency of the flat screw 40, and the control of the ejection of the forming material from the first nozzle 65 or the second nozzle 66 is simplified. “The amount of ejection of the forming material from the first nozzle 65 or the second nozzle 66” means the flow rate of the forming material that flows out from the first nozzle 65 or the second nozzle 66.

FIG. 5 is a sectional schematic view illustrating an outline configuration of the valve mechanism 70 in a first state. FIG. 6 is a sectional schematic view illustrating an outline configuration of the valve mechanism 70 in a second state. In the specification, the first state means a state of the three-dimensional forming apparatus 10 in which communication between the supply flow path 61 and the first branched flow path 63 is established and communication between the supply flow path 61 and the second branched flow path 64 is disconnected. Also, the second state means a state of the three-dimensional forming apparatus 10 in which the communication between the supply flow path 61 and the second branched flow path 64 is established and the communication between the supply flow path 61 and the first branched flow path 63 is disconnected.

The valve mechanism 70 is a valve configured to perform switching between the first state and the second state. The valve mechanism 70 includes a valve portion 71 that is configured to be able to rotate in the coupling portion 62 and that has a distribution path 72 through which the forming material can be distributed. Switching between the first state and the second state is performed by any one of the first branched flow path 63 and the second branched flow path 64 communicating with the supply flow path 61 via the distribution path 72 and by the other being disconnected from the supply flow path 61 by the valve portion 71 in response to the rotation of the valve portion 71. Also, the valve mechanism 70 according to the embodiment is configured to be able to adjust a first flow rate of the forming material to be flow into the first branched flow path 63 in the first state and a second flow rate of the forming material to be flow into the second branched flow path 64 in the second state by the valve portion 71 being configured such that a rotation angle thereof can be adjusted.

FIG. 7 is a perspective view illustrating the valve portion 71 according to the embodiment. The valve portion 71 according to the embodiment has a columnar shape with a central axis CA. The distribution path 72 is provided by a part of the side surface of the valve portion 71 is notched. An operation portion 73 is provided at one end of the valve portion 71. A motor that drives under control of the controller 90 is coupled to the operation portion 73. The valve portion 71 rotates by rotational drive force caused by the motor being applied to the operation portion 73.

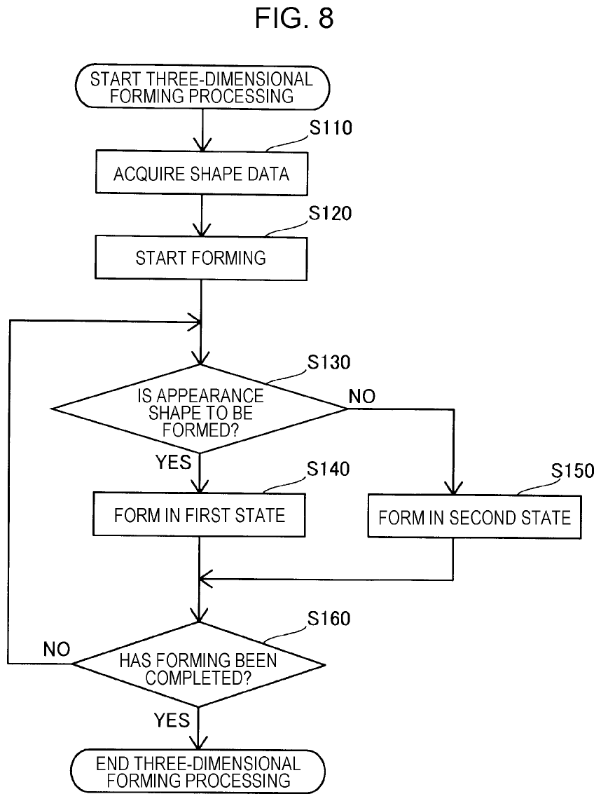

FIG. 8 is a flowchart illustrating details of three-dimensional forming processing for realizing forming of a three-dimensional object. The processing is executed in a case in which a predetermined forming start operation is performed by a user on an operation panel provided in the three-dimensional forming apparatus 10 or a computer connected to the three-dimensional forming apparatus 10. First, the controller 90 acquires shape data of a three-dimensional object in Step S110. The shape data is acquired from a computer or a recording medium connected to the three-dimensional forming apparatus 10, for example. At this time, the shape data is acquired as tool path data, in which data in an STL format or an AMF format representing the shape of the three-dimensional object is converted by a slicer. Next, the controller 90 starts to form the three-dimensional object in Step S120. If the formation of the three-dimensional object is started, the forming material is ejected from the first nozzle 65 or the second nozzle 66 through a material melting process in which the material is melted and the forming material is obtained by the forming material producing portion 30 and a supply process in which the melted forming material is supplied to the supply flow path 61.

The controller 90 determines whether or not a portion of the three-dimensional object to be formed corresponds to an appearance shape in Step S130. The appearance shape means a portion that is visible from the outside, in the complete shape of the three-dimensional object. A portion of the three-dimensional object other than the appearance shape will be referred to as an internal shape. The controller 90 can determine whether or not the portion of the three-dimensional object to be formed corresponds to the appearance shape using the tool path data acquired in Step S110, for example. Since higher quality than that of the internal shape is required for the appearance shape in terms of dimensional accuracy and surface roughness, the appearance shape is preferably finely formed by causing the forming material to be ejected from the nozzle with the small diameter. Meanwhile, since higher quality than that of the appearance shape is not required for the internal shape in terms of the dimensional accuracy and the surface roughness, the internal shape is preferably formed in a short period of time by causing the forming material to be ejected from the nozzle with the large diameter.

In a case in which it is determined that the portion of the three-dimensional object to be formed corresponds to the appearance shape in Step S130, the controller 90 forms the three-dimensional object in the first state by controlling the valve mechanism 70 in Step S140. Meanwhile, in a case in which it is not determined that the portion of the three-dimensional object to be formed corresponds to the appearance shape in Step S130, the controller 90 forms the three-dimensional object in the second state by controlling the valve mechanism 70 in Step S150. That is, the controller 90 performs switching to the first state or the second state in accordance with the portion of the three-dimensional object to be formed. Note that the formation by causing the first nozzle 65 to eject the forming material will also be referred to as a first forming process, and the formation by causing the second nozzle 66 to eject the forming material will also be referred to as a second forming process. In the first forming process and the second forming process, the flow rate of the forming material to be ejected may be adjusted in accordance with the moving speed of the nozzles. For example, it is possible to achieve a uniform thickness of the three-dimensional object by controlling the valve mechanism 70 to increase the flow rate of the forming material for a straight portion that forms the three-dimensional object and by reducing the flow rate of the forming material for a bended portion.

After Step S140 or Step S150, the controller 90 determines whether or not the formation of the three-dimensional object has been completed in Step S160. The controller 90 can determine whether or not the formation of the three-dimensional object has been completed using the tool path data acquired in Step S110, for example. In a case in which it is not determined that the formation of the three-dimensional object has been completed in Step S160, the controller 90 returns to the processing in Step S130 and continues to form the three-dimensional object. The controller 90 forms an internal shape in a first layer after forming an appearance shape in the first layer of the three-dimensional object, for example. The controller 90 forms the second layer on the first layer after forming the first layer of the three-dimensional object. Note that the controller 90 may form the appearance shape over a plurality of layers and then form the internal shape over a plurality of layers. In this manner, the controller 90 forms the three-dimensional object by stacking the forming material. Meanwhile, in a case in which it is determined that the formation of the three-dimensional object has been completed in Step S160, the controller 90 ends the processing. Note that in a case in which the ejection position of the forming material is moved to a remote position during the formation, the controller 90 suctions the forming material into the cylinder 112 by moving the plunger 111. It is possible to prevent the forming material from becoming stringy between the nozzle and the three-dimensional object even without stopping the rotation of the flat screw 40 by causing the forming material to be suctioned into the cylinder 112.

According to the three-dimensional forming apparatus 10 in the embodiment as described above, it is possible to perform the switching between the first state and the second state using the valve mechanism 70. Therefore, it is possible to form the three-dimensional object by separately using the two nozzles and thereby to improve producibility of the three-dimensional object by a single three-dimensional forming apparatus 10. In particular, the controller 90 drives the valve mechanism 70 and performs switching between the first state and the second state in accordance with the portion of the three-dimensional object to be formed in the embodiment. Therefore, it is possible to shorten the time for forming the three-dimensional object by causing the second nozzle 66 with the larger nozzle diameter than that of the first nozzle 65 to eject the forming material for the internal shape of the three-dimensional object that requires less quality than that of the appearance shape of the three-dimensional object in terms of dimensional accuracy and surface roughness.

In addition, the valve mechanism 70 is configured to be able to perform switching between the first state and the second state and is configured to be able to adjust the first flow rate and the second flow rate in the embodiment. Therefore, it is possible to further reduce the size of the three-dimensional forming apparatus 10 than in the case in which the valve for the switching between the first state and the second state and the valve for the adjustment between the first flow rate and the second flow rate are separately provided.

Also, the valve mechanism 70 is configured to perform switching between the first state and the second state in response to the rotation of the valve portion 71 with a columnar shape. Therefore, it is possible to perform the switching between the first state and the second state using the valve mechanism 70 with the simple configuration.

Also, the diameter Dn2 of the second nozzle 66 is larger than the diameter Dn1 of the first nozzle 65 in the embodiment. Therefore, it is possible to form the three-dimensional object by separately using the two nozzles with the different diameters and thereby to improve producibility of the three-dimensional object by the single three-dimensional forming apparatus 10.

Also, it is possible to quickly stop the ejection of the forming material from the first nozzle 65 by the first suctioning portion 67 causing the negative pressure in the first branched flow path 63 in the embodiment. In addition, it is possible to quickly stop the ejection of the forming material from the second nozzle 66 by the second suctioning portion 68 causing the negative pressure in the second branched flow path 64.

Also, since the forming material producing portion 30 generates the forming material using the flat screw 40 with a short length in the Z direction, it is possible to reduce the size of the three-dimensional forming apparatus 10 in the embodiment.

Note that although the ABS resin material in the pellet form is used in the embodiment, a material of forming a three-dimensional object that contains, as main materials, various materials such as a thermoplastic material, a metal material, and a ceramic material, for example, can also be employed as materials used by the forming unit 100. Here, the “main materials” means materials that mainly form the shape of the three-dimensional object and means materials that occupy the content of 50% by weight or more in the three-dimensional object. The aforementioned forming material include such materials melted alone and a material in a paste form in which a part of constituents contained along with the main materials is melted.

When the thermoplastic material is used as the main material, the forming material is produced by plasticizing the corresponding material in the forming material producing portion 30. “Plasticizing” refers to applying heat to the thermoplastic material to be melted.

As the thermoplastic material, for example, one kind or a combination of two or more kinds selected from the following thermoplastic resin materials can be used. Examples of Thermoplastic Resin Material

A general engineering plastic such as a polypropylene resin (PP), a polyethylene resin (PE), a polyacetal resin (POM), a polyvinyl chloride resin (PVC), a polyamide resin (PA), an acrylonitrile-butadiene-styrene resin (ABS), a polylactic acid resin (PLA), a polyphenylene sulfide resin (PPS), polyether ether ketone (PEEK), polycarbonate (PC), modified polyphenylene ether, polybutylene terephthalate, or polyethylene terephthalate; and an engineering plastic such as polysulfone, polyether sulfone, polyphenylene sulfide, polyarylate, polyimide, polyamide imide, polyether imide, or polyether ether ketone

A pigment, a metal, a ceramic, or an additive such as a wax, a flame retardant, an antioxidant, or a heat stabilizer may be incorporated into the thermoplastic material. The thermoplastic material is plasticized and melted by the rotation of the flat screw 40 and the heating of the heater 58 in the forming material producing portion 30. In addition, the forming material produced as described above is ejected from the first nozzle 65 or the second nozzle 66 and then is cured by a temperature decrease.

It is desirable that the thermoplastic material be heated at a temperature that is equal to or greater than a glass transition point and be ejected from the first nozzle 65 and the second nozzle 66 in a state in a completely melted state. For example, the glass transition point of ABS resin is about 120° C., and it is desirable that the temperature thereof be about 200° C. when the ABS resin is ejected from the first nozzle 65 or the second nozzle 66. A heater may be provided in the surroundings of the first nozzle 65 and the second nozzle 66 in order to eject the forming material in such a high-temperature state.

In the forming unit 100, for example, the following metal material may be used as the main material instead of the thermoplastic material. In this case, it is preferable that components melted during the production of the forming material are mixed with a powder material of the following metal materials and the mixture is poured into the forming material producing portion 30. Example of Metal Material

One kind of metal or an alloy including one or more kinds selected from magnesium (Mg), iron (Fe), cobalt (Co), chromium (Cr), aluminum (Al), titanium (Ti), copper (Cu), and nickel (Ni)

### Example of Alloy

Maraging steel, stainless steel, cobalt-chromium-molybdenum, titanium alloys, nickel alloys, aluminum alloys, cobalt alloys, and cobalt-chromium alloys

In the forming unit 100, a ceramic material may be used as the main material instead of the metal material. As the ceramic material, for example, an oxide ceramic such as silicon dioxide, titanium dioxide, aluminum oxide, or zirconium oxide or a non-oxide ceramic such as aluminum nitride can be used. When the metal material or the ceramic material is used as the main material, the forming material disposed on the forming table 81 may be cured through sintering by laser irradiation, hot air blowing, or the like.

The powder material of the metal material or the ceramic material to be poured into the material supply portion 20 may be a mixed material obtained by mixing plural kinds of single metal powders or alloy powders, or ceramic material powders. In addition, the powder material of the metal material or the ceramic material may be coated with the above-described thermoplastic resins or other thermoplastic resins. In this case, in the forming material producing portion 30, this thermoplastic resin may be melted to exhibit fluidity.

For example, the following solvent can also be added to the powder material of the metal material or the ceramic material to be poured into the material supply portion 20. As the solvent, one kind or a combination of two or more kinds selected from the above examples can be used.

### Examples of Solvent

Water; (poly)alkylene glycol monoalkyl ethers such as ethylene glycol monomethyl ether, ethylene glycol monoethyl ether, propylene glycol monomethyl ether, or propylene glycol monoethyl ether; acetates such as ethyl acetate, n-propyl acetate, isopropyl acetate, n-butyl acetate, or isobutyl acetate; aromatic hydrocarbons such as benzene, toluene, or xylene; ketones such as methyl ethyl ketone, acetone, methyl isobutyl ketone, ethyl-n-butyl ketone, diisopropyl ketone, or acetyl acetone; alcohols such as ethanol, propanol, or butanol; tetraalkylammonium acetates; sulfoxide solvents such as dimethyl sulfoxide or diethyl sulfoxide; pyridine solvents such as pyridine, γ-picoline, or 2,6-lutidine; tetraalkylammonium acetates (for example, tetrabutylammonium acetate); and ionic liquids such as butyl carbitol acetate

In addition, the following binder can also be added to the powder material of the metal material or the ceramic material to be poured into the material supply portion 20.

### Examples of Binder

An acrylic resin, an epoxy resin, a silicone resin, a cellulose resin, or other synthetic resins; and thermoplastic resins such as polylactic acid (PLA), polyamide (PA), polyphenylene sulfide (PPS), polyether ether ketone (PEEK), or other thermoplastic resins

### B. Second Embodiment

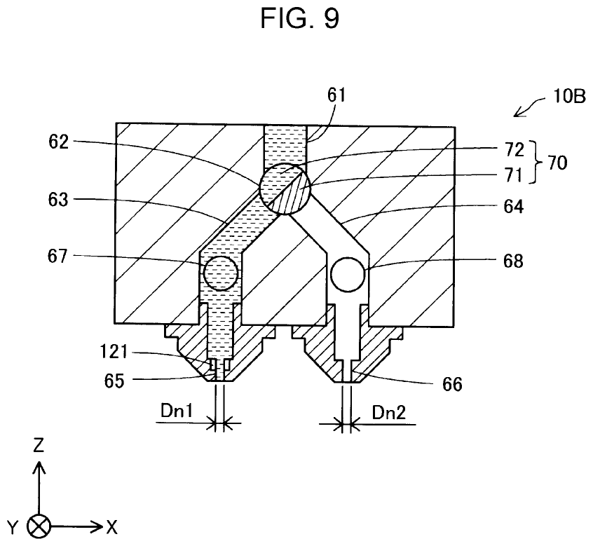

FIG. 9 is an explanatory diagram illustrating an outline configuration of a three-dimensional forming apparatus 10B according to a second embodiment. The three-dimensional forming apparatus 10B according to the second embodiment is different from the first embodiment in that diameter Dn1 of the first nozzle 65 is the same as the diameter Dn2 of the second nozzle 66 and in details of the three-dimensional forming processing. The other configurations are the same as those in the first embodiment as illustrated in FIG. 1. In the second embodiment, the second nozzle 66 is used as a preliminary nozzle. That is, the forming material is ejected from the second nozzle 66 only in a case in which an ejection failure occurs in the first nozzle 65. The ejection failure means occurrence of abnormality in the ejection of the forming material from the nozzle due to clogging of the nozzle or breakage of the nozzle.

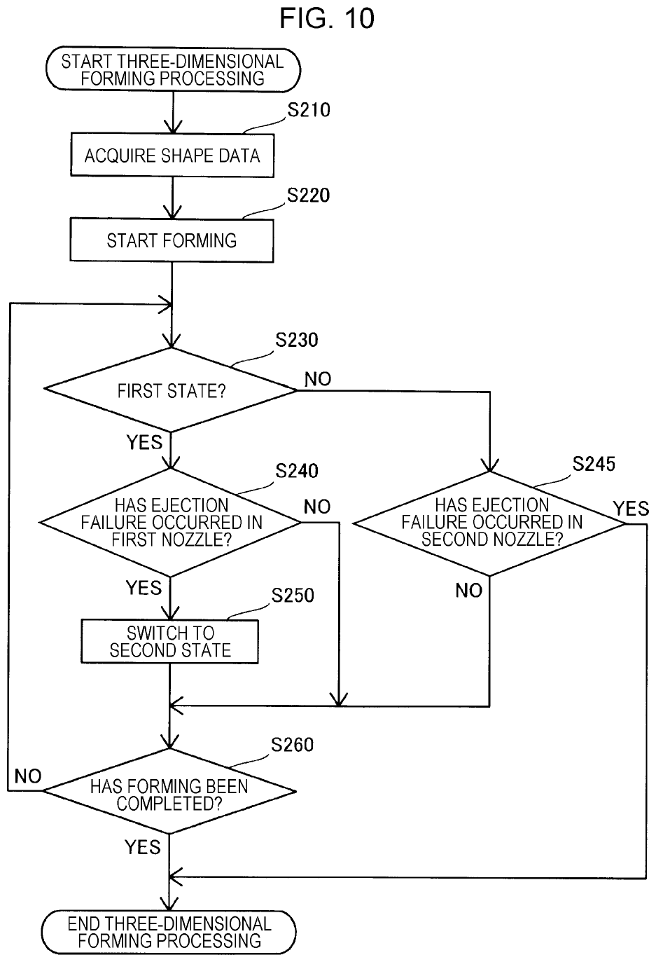

FIG. 10 is a flowchart illustrating details of the three-dimensional forming processing according to the second embodiment. The processing is executed in a case in which a predetermined forming start operation is performed by a user on an operation panel provided in the three-dimensional forming apparatus 10B or a computer connected to the three-dimensional forming apparatus 10B. The controller 90 acquires shape data of a three-dimensional object in Step S210 and starts to form the three-dimensional object in Step S220. Details of Step S210 and Step S220 are the same as those in Step S110 and Step S120 in the three-dimensional forming processing according to the first embodiment. After Step S220, the controller 90 determines whether or not the three-dimensional forming apparatus 10B is in the first state in Step S230.

In a case in which it is determined that the three-dimensional forming apparatus 10B is in the first state in Step S230, the controller 90 determines whether or not an ejection failure has occurred in the first nozzle 65 in Step S240. In the embodiment, a flow rate sensor 121 for detecting the flow rate of the forming material ejected from the first nozzle 65 is provided at the first nozzle 65, and the controller 90 acquires a value of the flow rate detected by the flow rate sensor 121. Whether or not an ejection failure has occurred in the first nozzle 65 is determined by the controller 90 determining whether or not the acquired value of the flow rate falls within a range of a normal value of a flow rate stored in advance in the controller 90.

In a case in which it is determined that an ejection failure has occurred in the first nozzle 65 in Step S240, the controller 90 drives the valve mechanism 70 in Step S250 and switches the three-dimensional forming apparatus 10B from the first state to the second state. Meanwhile, in a case in which it is not determined that an ejection failure has occurred in the first nozzle 65 in Step S240, the controller 90 omits Step S250 and moves on to the processing in Step S260. Thereafter, the controller 90 determines whether or not the formation of the three-dimensional object has been completed in Step S260. Details of Step S260 are the same as those of Step S160 in the three-dimensional forming processing according to the first embodiment. In a case in which it is not determined that the formation of the three-dimensional object has been completed in Step S260, the controller 90 returns to the processing in Step S230 and continues to form the three-dimensional object. Meanwhile, in a case in which it is determined that the formation of the three-dimensional object has been completed in Step S260, the controller 90 ends the processing.

In a case in which it is not determined that the three-dimensional forming apparatus 10B is in the first state in Step S230, that is, in a case in which the three-dimensional forming apparatus 10B is in the second state, the controller 90 determines whether or not an ejection failure has occurred in the second nozzle 66 in Step S245. The controller 90 determines whether or not an ejection failure has occurred in the second nozzle 66 similarly to the case in which it is determined whether or not an ejection failure has occurred in the first nozzle 65, in Step S240. In a case in which it is not determined that an ejection failure has occurred in the second nozzle 66 in Step S245, the controller 90 moves on to the processing in Step S260 as described above. Meanwhile, in a case in which it is determined that an ejection failure has occurred in the second nozzle 66 in Step S245, the controller 90 omits Step S260 and ends the three-dimensional forming processing. That is, the controller 90 suspends the three-dimensional forming processing in this case. Note that the first nozzle 65 or the second nozzle 66 in which an ejection failure has occurred may be repaired or replaced after the three-dimensional forming processing is suspended.

According to the three-dimensional forming apparatus 10B in the embodiment as described above, it is possible to cause the second nozzle 66 to eject the forming material and to continue to form the three-dimensional object without interrupting the formation of the three-dimensional object for repairment or replacement of the first nozzle 65 even if an ejection failure has occurred in the first nozzle 65 when the first nozzle 65 is caused to eject the forming material and the three-dimensional object is formed. Therefore, it is possible to improve producibility of the three-dimensional object.

Note that although the description has been given on the assumption that the diameter Dn1 of the first nozzle 65 is the same as the diameter Dn2 of the second nozzle 66, the diameter Dn1 of the first nozzle 65 may be different from the diameter Dn2 of the second nozzle 66 in the embodiment.

### C. Third Embodiment

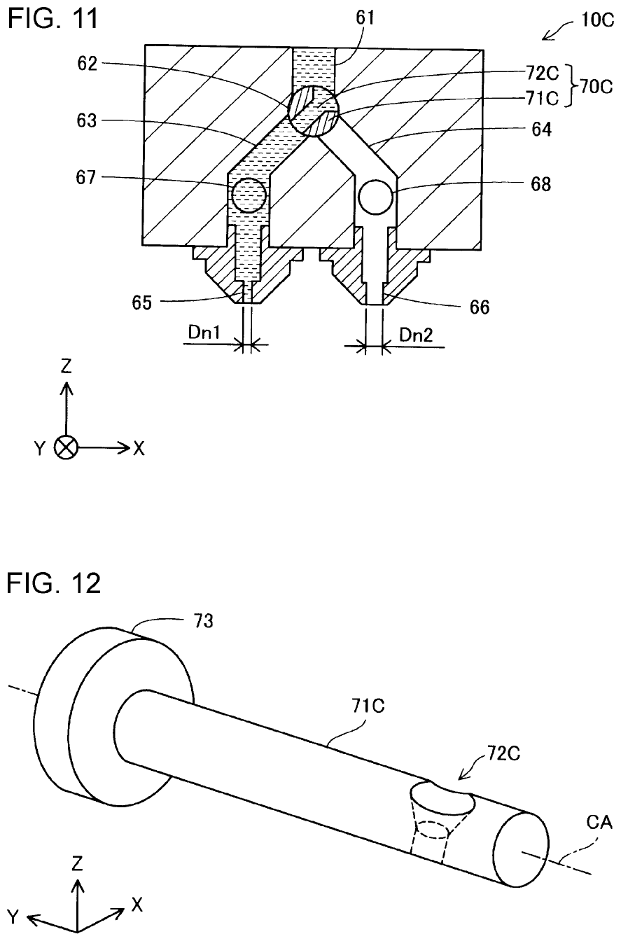

FIG. 11 is an explanatory diagram illustrating an outline configuration of a three-dimensional forming apparatus 10C according to a third embodiment. The three-dimensional forming apparatus 10C according to the third embodiment is different from the first embodiment in a configuration of a valve mechanism 70C. The other configurations are the same as those in the first embodiment as illustrated in FIG. 1. FIG. 11 illustrates the valve mechanism 70C in the first state.

FIG. 12 is a perspective view illustrating an outline configuration of a valve portion 71C according to the third embodiment. The valve portion 71C according to the third embodiment has a columnar shape with a central axis CA. A distribution path 72C is provided as a through-hole with a funnel shape provided at the valve portion 71C.

According to the three-dimensional forming apparatus 10C in the embodiment as described above, it is also possible to perform switching between the first state and the second state in response to rotation of the valve portion 71C.

### D. Other Embodiments

(D1) According to the three-dimensional forming apparatuses 10, 10B, and 10C in the aforementioned respective embodiments, the valve mechanisms 70 and 70C include the valve portions 71 and 71C with the columnar shapes configured to be able to rotate in the coupling portion 62. Meanwhile, the valve mechanisms 70 and 70C may include valve portions 71 and 71C with semi-spherical shapes configured to be able to rotate in the coupling portion 62.

(D2) According to the three-dimensional forming apparatuses 10, 10B, and 10C in the aforementioned respective embodiments, the valve mechanisms 70 and 70C are configured to adjust the first flow rate of the forming material to be flowed into the first branched flow path 63 in the first state and the second flow rate of the forming material flowed into the second branched flow path 64 in the second state. Meanwhile, the valve mechanism 70 and 70C may be configured to merely perform switching between the first state and the second state without adjusting the first flow rate of the forming material flowed into the first branched flow path 63 in the first state and the second flow rate of the forming material flowed into the second branched flow path 64 in the second state.

(D3) According to the three-dimensional forming apparatus 10, 10B, and 10C in the aforementioned respective embodiments, the first suctioning portion 67 and the second suctioning portion 68 include the plunger 111 that reciprocates in the cylinder 112. Meanwhile, the first suctioning portion 67 and the second suctioning portion 68 may be configured such that the forming material is suctioned from the first branched flow path 63 and the second branched flow path 64 using a pump or the like instead of the plunger 111. The suctioned forming material may be discharged to the outside of the first branched flow path 63 and to the outside of the second branched flow path 64. Also, the three-dimensional forming apparatuses 10, 10B, and 10C may not include the first suctioning portion 67 and the second suctioning portion 68.

(D4) The three-dimensional forming apparatuses 10, 10B, and 10C in the aforementioned respective embodiments include the first nozzle 65 and the second nozzle 66. Meanwhile, the three-dimensional forming apparatuses 10, 10B, and 10C further may include a third nozzle, and the valve mechanisms 70 and 70C may be configured such that the forming material is ejected from any of the first nozzle 65, the second nozzle 66, and the third nozzle.

(D5) According to the three-dimensional forming apparatuses 10, 10B, and 10C in the aforementioned respective embodiments, the forming material producing portion 30 includes the flat screw 40. Meanwhile, the forming material producing portion 30 may include a longer in-line screw than the flat screw 40 in the Z direction instead of the flat screw 40.

(D6) According to the three-dimensional forming apparatuses 10, 10B, and 10C in the aforementioned respective embodiments, the motor that is coupled to the operation portion 73 of the valve mechanism 70 and that is driven under control of the controller 90 performs switching between the first state and the second state. Meanwhile, switching between the first state and the second state may be performed by the user manually operating the operation portion 73.

(D7) According to the three-dimensional forming apparatus 10B in the aforementioned second embodiment, the flow rate sensor 121 for detecting the flow rate of the forming material to be ejected from the first nozzle 65 is provided at the first nozzle 65, and the controller 90 determines whether or not an ejection failure has occurred in the first nozzle 65 using the value of the flow rate detected by the flow rate sensor 121. Meanwhile, a pressure sensor for detecting a pressure of the forming material in the first branched flow path 63 may be provided in the first branched flow path 63, and the controller 90 may determine whether or not an ejection failure has occurred in the first nozzle 65 using a value of the pressure detected by the pressure sensor. Also, a weight sensor for detecting a weight of the stack on the forming table 81 may be provided at the forming table 81, and the controller 90 may determine whether or not an ejection failure has occurred in the first nozzle 65 using a value of the weight detected by the weight sensor. A camera may be provided on a side of the first nozzle 65, and the controller 90 may determine whether or not an ejection failure has occurred in the first nozzle 65 by the controller 90 determining whether or not the forming material is appropriately being ejected from the first nozzle 65. Whether or not an ejection failure has occurred in the first nozzle 65 may be determined by three-dimensional shape data being created by measuring the three-dimensional object using a three-dimensional digitizer and by the created shape data being matched with shape data used when the tool path data is generated.

(D8) The controller 90 may determine whether or not an ejection failure has occurred in the first nozzle 65 in the three-dimensional forming apparatus 10B in the aforementioned second embodiment. Meanwhile, the user may visually observe a situation of ejection of the forming material from the first nozzle 65, and the user may determine whether or not an ejection failure has occurred in the first nozzle 65. In this case, a switch for driving the motor coupled to the operation portion 73 of the valve mechanism 70 may be provided, and the user who has determined that an ejection failure has occurred in the first nozzle 65 may perform switching between the first state and the second state by operating the switch, for example. Also, the user may perform switching between the first state and the second state by manually operating the operation portion 73.

(D9) In the three-dimensional forming apparatuses 10, 10B, and 10C in the aforementioned respective embodiments, the three-dimensional forming processing according to the first embodiment and the three-dimensional forming processing according to the second embodiment may be combined. In this case, the controller 90 performs switching between the first state and the second state in accordance with a portion of the three-dimensional object to be formed, and in a case in which it is determined that an ejection failure has occurred in the first nozzle 65, the controller 90 performs switching from the first state to the second state. In this case, the controller 90 may perform switching from the second state to the first state in a case in which it is determined that an ejection failure has occurred in the second nozzle 66, and the controller 90 may suspend the three-dimensional forming processing in a case in which it is determined that ejection failures have occurred in both the first nozzle 65 and the second nozzle 66.

(D10) According to the three-dimensional forming apparatus 10 in the aforementioned first embodiment, the controller 90 determines whether or not the portion of the three-dimensional object to be formed corresponds to an appearance shape in Step S130, the controller 90 forms the three-dimensional object in the first state in a case in which it is determined that the portion corresponds to the appearance shape, and the controller 90 may form the three-dimensional object in the second state in a case in which it is not determined that the portion corresponds to the appearance shape, as illustrated in FIG. 8. In contrast, the controller 90 may form the three-dimensional object in the first state in a case in which the line width of the forming material to be ejected from the nozzle is set to be thin and may form the three-dimensional object in the second state in a case in which the line width is set to be thick, in accordance with the portion of the three-dimensional object irrespective of whether or not the portion corresponds to the appearance shape or the internal shape.

(D11) According to the three-dimensional forming apparatus 10B in the aforementioned second embodiment, the controller 90 omits Step S260 and suspends the three-dimensional forming processing in a case in which it is determined that an ejection failure has occurred in the second nozzle 66 in Step S245 as illustrated in FIG. 10. Meanwhile, the controller 90 may drive the valve mechanism 70 and may switch the three-dimensional forming apparatus 10B from the second state to the first state in a case in which it is determined that an ejection failure has occurred in the second nozzle 66 in Step S245. In this case, it is possible to continue to form the three-dimensional object by the first nozzle 65 even in a case in which an ejection failure has occurred in the second nozzle 66 by repairing or replacing the first nozzle 65 in the course of the formation of the three-dimensional object with the second nozzle 66.

### E. Other Aspects

The present disclosure is not limited to the above-described embodiments and can be realized in various aspects within a range not departing from the scope of the disclosure. For example, the present disclosure can be realized by the following aspects. For example, the technical features of any one of the embodiments corresponding to the technical features of any one of the aspects described below can be appropriately replaced or combined in order to solve a part or all of the problems of the present disclosure or to achieve a part or all of the effects of the present disclosure. In addition, the technical features may be appropriately omitted unless they are described as essential features in this specification.

(1) According to an aspect of the disclosure, a three-dimensional forming apparatus is provided. The three-dimensional forming apparatus includes: a material melting portion that melts a material and obtains a forming material; a supply flow path through which the forming material supplied from the material melting portion is distributed; a first branched flow path and a second branched flow path to which the forming material is supplied from the supply flow path; a coupling portion that couples the supply flow path to the first branched flow path and the second branched flow path; a first nozzle that communicates with the first branched flow path; a second nozzle that communicates with the second branched flow path and that has a larger nozzle diameter than a nozzle diameter of the first nozzle; and a valve mechanism that is provided at the coupling portion. Switching between a first state in which communication between the supply flow path and the first branched flow path is established and coupling between the supply flow path and the second branched flow path is disconnected and a second state in which the communication between the supply flow path and the second branched flow path is established and the communication between the supply flow path and the first branched flow path is disconnected is performed using the valve mechanism.

According to the three-dimensional forming apparatus of the aspect, it is possible to perform switching between the first state and the second state using the valve mechanism. Therefore, it is possible to form the three-dimensional object by separately using the two nozzles with different nozzle diameters in the single three-dimensional forming apparatus and thereby to improve producibility while securing dimensional accuracy of the three-dimensional object.

(2) In the three-dimensional forming apparatus of the aspect, the valve mechanism may be configured such that the valve mechanism is able to adjust a flow rate of the melted material that flows into the first branched flow path or the second branched flow path.

According to the three-dimensional forming apparatus of the aspect, it is possible to perform switching between the first state and the second state and the adjustment between a first flow rate and a second flow rate using a single valve mechanism. Therefore, it is possible to reduce the size of the three-dimensional forming apparatus as compared with a case in which a valve for the switching between the first state and the second state and a valve for the adjustment between the first flow rate and the second flow rate are separately provided.

(3) In the three-dimensional forming apparatus of the aspect, the valve mechanism may have a valve portion that is configured to be able to rotate in the coupling portion and that has a distribution path through which the forming material is able to be distributed, and may perform switching between the first state and the second state by any one of the first branched flow path and the second branched flow path communicating with the supply flow path via the distribution path and by the other being disconnected from the supply flow path by the valve portion in response to the rotation of the valve portion.

According to the three-dimensional forming apparatus of the aspect, it is possible to perform switching between the first state and the second state using the valve mechanism with a simple configuration.

(4) The three-dimensional forming apparatus of the aspect further may include a controller that controls the valve mechanism and may switch the first state and the second state in accordance with a portion of a three-dimensional object to be formed.

According to the three-dimensional forming apparatus of the aspect, it is possible to shorten the time for forming the three-dimensional object by causing the second nozzle with the larger nozzle diameter than that of the first nozzle to eject the forming material for an internal shape of the three-dimensional object that requires less quality than that of an appearance shape of the three-dimensional object in terms of dimensional accuracy and surface roughness.

(5) The three-dimensional forming apparatus of the aspect may further include: a first suctioning portion that is coupled to the first branched flow path and that is configured such that the first suctioning portion is able to suction the forming material in the first branched flow path; and a second suctioning portion that is coupled to the second branched flow path and that is configured such that the second suctioning portion is able to suction the forming material in the second branched flow path.

According to the three-dimensional forming apparatus of the aspect, it is possible to quickly stop the ejection of the forming material from the first nozzle by the first suctioning portion causing a negative pressure in the first branched flow path. Also, it is possible to quickly stop the ejection of the forming material from the second nozzle by the second suctioning portion causing a negative pressure in the second branched flow path.

(6) In the three-dimensional forming apparatus of the aspect, the material melting portion may have a flat screw, and the material may be melted, and the forming material may be obtained using the rotating flat screw.

According to the three-dimensional forming apparatus of the aspect, it is possible to reduce the size of the three-dimensional forming apparatus since the forming material is generated using the small-sized flat screw.

The disclosure can be realized in various aspects other than the three-dimensional forming apparatus. For example, the disclosure can be realized in aspects such as a method of forming a three-dimensional object, a computer program that realizes the method, and a non-transitory recording medium that records the computer program therein.

What is claimed is:

1. A three-dimensional forming apparatus comprising:
a material melting portion that melts a material and obtains a forming material;
a supply flow path through which the forming material supplied from the material melting portion is distributed;
a first branched flow path and a second branched flow path to which the forming material is supplied from the supply flow path;
a coupling portion that couples the supply flow path to the first branched flow path and the second branched flow path;
a first nozzle that communicates with the first branched flow path;
a second nozzle that communicates with the second branched flow path and has a larger nozzle diameter than a nozzle diameter of the first nozzle; and
a valve mechanism that is provided at the coupling portion, wherein
the valve mechanism performs switching between
a first state in which communication between the supply flow path and the first branched flow path is established and communication between the supply flow path and the second branched flow path is disconnected, and
a second state in which the communication between the supply flow path and the second branched flow path is established and the communication between the supply flow path and the first branched flow path is disconnected.

2. The three-dimensional forming apparatus according to claim 1, wherein
the valve mechanism is configured such that a flow rate of the melted material that flows into the first branched flow path or the second branched flow path is adjusted.

3. The three-dimensional forming apparatus according to claim 1, wherein
the valve mechanism
includes a valve portion that is configured to be able to rotate in the coupling portion and that has a distribution path through which the forming material is distributed, and
performs switching between the first state and the second state by any one of the first branched flow path and the second branched flow path communicating with the supply flow path via the distribution path and by the other being disconnected from the supply flow path by the valve portion in response to the rotation of the valve portion.

4. The three-dimensional forming apparatus according to claim 1, further comprising:
a controller that controls the valve mechanism, wherein
the controller performs switching between the first state and the second state in accordance with a portion of a three-dimensional object to be formed.

5. The three-dimensional forming apparatus according to claim 1, further comprising:
a first suctioning portion that is coupled to the first branched flow path and that is configured such that the first suctioning portion is able to suction the forming material in the first branched flow path; and
a second suctioning portion that is coupled to the second branched flow path and that is configured such that the second suctioning portion is able to suction the forming material in the second branched flow path.

6. The three-dimensional forming apparatus according to claim 1, wherein
the material melting portion has a flat screw, melts the material using the rotating flat screw, and obtains the forming material.

7. A method of forming a three-dimensional object comprising:
melting a material and obtaining a forming material;
supplying the forming material to a supply flow path;
causing a first nozzle to eject the forming material supplied to the supply flow path via a first branched flow path and forming the three-dimensional object;
causing a second nozzle that has a larger nozzle diameter than a nozzle diameter of the first nozzle to eject the forming material supplied to the supply flow path via a second branched flow path and forming the three-dimensional object; and
switching the causing of the first nozzle to eject the forming material and the causing of the second nozzle to eject the forming material by switching a first state in which communication between the supply flow path and the first branched flow path is established and communication between the supply flow path and the second branched flow path is disconnected and a second state in which communication between the supply flow path and the second branched flow path is established and communication between the supply flow path and the first branched flow path is disconnected, using a valve mechanism that is provided at a coupling portion that couples the supply flow path to the first branched flow path and the second branched flow path.
